(19) United States
(12) Patent Application Publication
(10) Pub. No.: US 2014/0234500 A1
(43) Pub. Date: Aug. 21, 2014

(54) METHOD AND DEVICE FOR EDIBLE PRINTING ON FOODSTUFFS

(71) Applicants: John Kamb, JR., (US); Michele Youngquist, (US)

(72) Inventors: Elizabeth A. Mitchell, Mount Vernon, WA (US); Michele Youngquist, Mount Vernon, WA (US)

(73) Assignee: Michele Youngquist, Burlington, WA (US)

(21) Appl. No.: 14/345,228

(22) PCT Filed: Sep. 28, 2012
(86) PCT No.: PCT/US2012/057984

§ 371 Date: Mar. 14, 2014

Related U.S. Application Data
(60) Provisional application No. 61/540,705, filed on Sep. 29, 2011.

(51) Int. Cl. A23P 1/08

(52) U.S. Cl. CPC A23P 1/085; A23P 2001/089
USPC 426/302; 118/13

(57) ABSTRACT

The method and device for edible printing (10) on foodstuffs includes a printing workstation (20) having a base (22), a conveyor (30) disposed on the base (22), and a gantry frame (24) mounted above the base (22) and conveyor (30). The conveyor (30) carries at least one foodstuff processing tray (40) from one end of the printing workstation (20) to another. The foodstuff processing tray (40) includes at least one cavity (42) shaped to hold a foodstuff (F) securely therein. A crossbeam (52) is slidably mounted to the gantry frame (24) above the conveyor (30) and movable in one direction. A carriage (54) is mounted to the crossbeam (52) and movable along the length thereof in a perpendicular direction to the to movement of the crossbeam (52). The carriage (54) holds a reciprocating printhead (70) for marking edible printing (10) onto the surface of the foodstuffs (F) being processed.

### TECHNICAL FIELD

The present invention relates to automated systems for labeling goods for sale, and particularly to a method and device for edible printing on foodstuffs.

### BACKGROUND ART

Due to various disclosure regulations for retail sales of goods, and particularly retail sales of food products, and the fact that the modern consumer expects information on purchased products, it is a common practice to apply various stickers to individual fruits and vegetables. These stickers display such information as date codes, location of origin, or even UPC codes used in automatic check-out registers.

However, such stickers are prone to peeling from the surface of the produce, which can create confusion from apparatus processing the produce and/or the person requiring the information thereon. Additionally, such stickers can cause problems in various types of automated produce handling equipment. Fallen stickers can be found all over grocery stores and even in one's home, and this scattered debris becomes an unappealing and non-aesthetic panorama that must be cleaned, especially in a place of business. Finally, such stickers must be removed before food preparation, which requires an inordinate amount of time, especially in commercial food preparation facilities, such as restaurants.

In light of the above, it would be a benefit in the art of food processing to provide the necessary information on foodstuffs without the hassles of adhesive stickers. Thus, a method and device for edible printing on foodstuffs solving the aforementioned problems is desired.

### DISCLOSURE OF INVENTION

The method and device for edible printing on foodstuffs includes a printing workstation having a base, a conveyor disposed on the base and a gantry frame mounted above the base and conveyor. The conveyor carries at least one foodstuff processing tray from one end of the printing workstation to another. The foodstuff processing tray includes at least one cavity shaped to hold a foodstuff securely therein. A crossbeam is slidably mounted to the gantry frame above the conveyor and movable in one direction. A carriage is mounted to the crossbeam and movable along the length thereof in a perpendicular direction to the movement of the crossbeam. The carriage holds a reciprocating printhead for marking edible printing onto the surface of the foodstuffs being processed.

These and other features of the present invention will become readily apparent upon further review of the following specification and drawings.

### BRIEF DESCRIPTION OF THE DRAWINGS

FIG. 1A is an environmental, perspective view of edible printing on an exemplary foodstuff (an apple) according to the present invention.

FIG. 1B is an environmental, perspective view of edible printing on another exemplary foodstuff (a banana) according to the present invention.

FIG. 2 is a perspective view of a device for edible printing on foodstuffs according to the present invention, showing the general configuration of an exemplary workstation.

FIG. 3 is a partial front view of the exemplary workstation of FIG. 2, shown partially in section and illustrating the configuration of the printhead area of the workstation.

FIG. 4 is a partial front view of an alternative embodiment of the printhead area of the exemplary workstation of FIG. 2.

FIG. 5 is a schematic view of an alternative embodiment of a device for edible printing on foodstuffs according to the present invention, showing a processing line having multiple printheads for edible printing onto foodstuffs in a large scale food processing plant.

Similar reference characters denote corresponding features consistently throughout the attached drawings.

### BEST MODE(S) FOR CARRYING OUT THE INVENTION

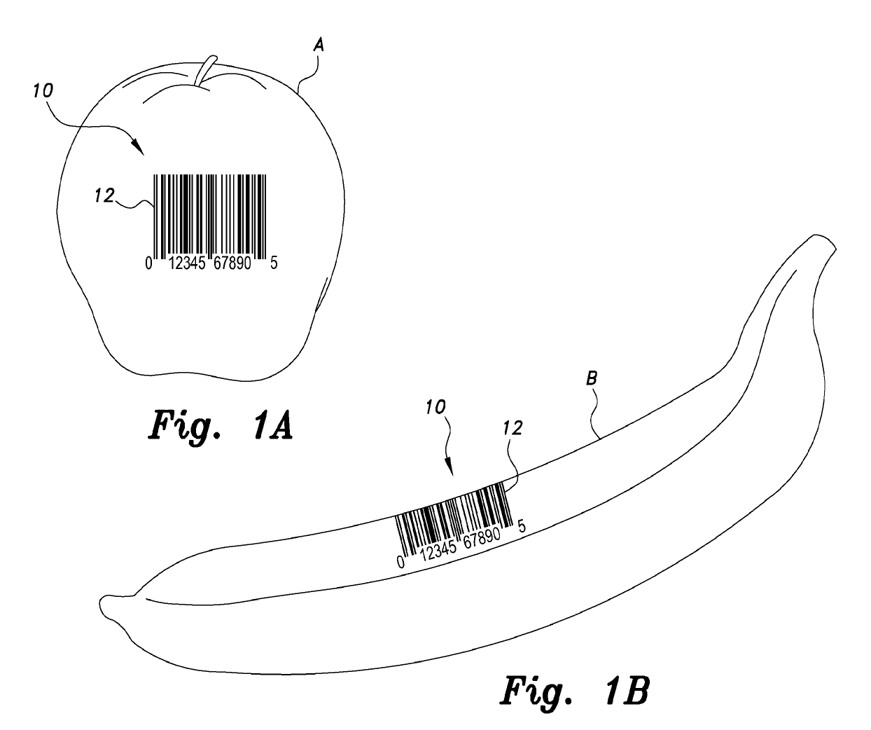

FIGS. 1A and 1B show environmental views of edible printing 10 on foodstuffs, such as an apple A and a banana B. These foodstuffs A, B are exemplary, and it is noted that the edible printing 10 can be applied to any foodstuff surface that can be printed. The edible printing 10 includes informational marking, such as a barcode 12. The barcode 12 or any similar marking represents information, such as UPC codes, date codes, location of origin, tracking codes, and other information that is to be applied directly upon surface of the foodstuff A, B.

The method and device for edible printing on foodstuffs replaces the current practice of using stickers to communicate such information and eliminates the possibility of stickers falling off, gumming of machinery, and the like. Additionally, the edible printing 10 eliminates the time-consuming task of removing stickers prior to food preparation.

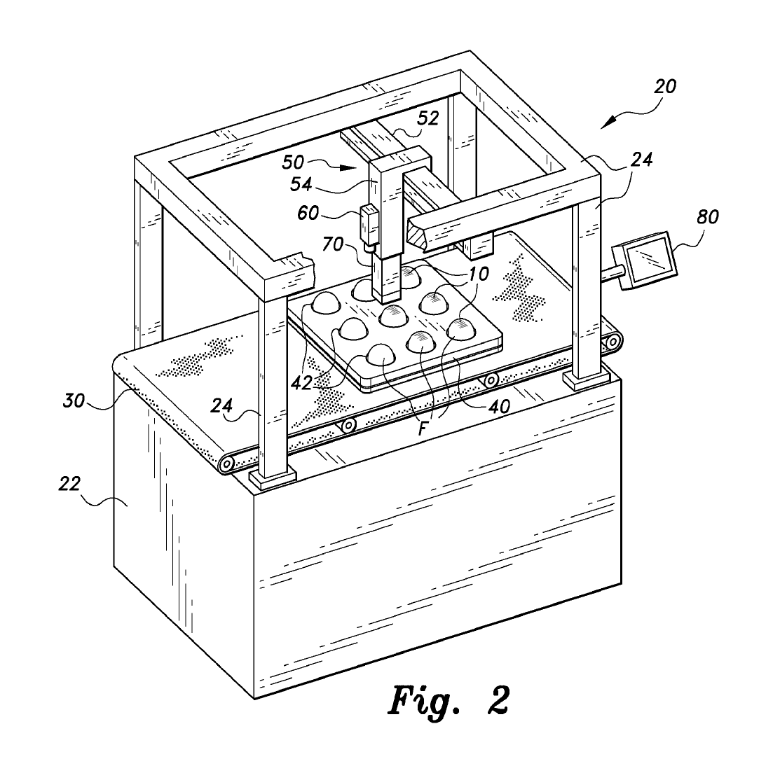

An example of a first embodiment of a device for edible printing is shown in FIG. 2. In this embodiment, the device is embodied as a printing workstation 20 that includes a base 22, a conveyor 30 mounted on top of the base 22, a gantry frame 24, a multi-axis manipulator 50 operatively mounted to the gantry frame 24, a printhead 70 connected to the manipulator 50, a vision system 60 and a controller 80. Preferably, the printing workstation 20 is automated and computer-controlled for high-volume throughput processing of foodstuffs F. It is noted that the term “printhead” as used herein can also be referred to as an edible print applicator.

A foodstuff processing tray 40 is disposed on the conveyor 30 and holds a plurality of foodstuffs F in molded cavities 42 for pre-positioning the foodstuffs F prior to imprinting the foodstuff with edible printing 10. The conveyor 30 is depicted as an endless belt that can be driven in one direction or in reversible directions for accurate pre-positioning. The processing tray 40 can be either a separate component freely supported on the conveyor 30 or an integrated component attached to or extending from the conveyor 30. In the latter case, it is preferable for the endless belt to be segmented so that each segment supports an individual tray 40 in order to permit travel of the belt around the drive or driven rollers without interference. The processing tray 40 is preferably constructed from plastic, and each cavity or pocket 42 defines a concave shape for snugly holding individual foodstuffs F therein. The cavities 42 are also shaped to correspond with the particular type of foodstuff F being printed upon. Thus, the conveyor 30 can be filled with a plurality of processing trays 40 holding differently shaped foodstuffs F in one or more of the trays 40. Since some foodstuffs F can be damaged if not handled properly, the plastic construction provides some flex that securely holds the foodstuff F without bruising. Other materials, such as cardboard or paper products, rubber, silicon, or combinations thereof can also be used to construct the tray 40. Harder materials, such as metal, steel, wood and derivatives thereof, can also be used in situations where the foodstuffs F are relatively durable and potential damage from improper handling is minimal.

The manipulator 50 includes a crossbeam 52 slidably mounted to opposing frame members of the gantry frame 24 disposed above the conveyor 30. The crossbeam 52 is movable along the side frame members in a direction parallel to the direction of movement of the conveyor belt. A carriage 54 is slidably mounted to the crossbeam 52. The crossbeam 52 functions as a track, facilitating movement of the carriage 54 perpendicular to the direction of movement of the conveyor belt. The movements of both the crossbeam 52 and the carriage 54 can be actuated by any known means, such as linear actuators, pneumatic devices, push-pull systems, rack and pinion drives, screw drives and the like.

The vision system 60 is mounted to the carriage 54 and provides video capture and monitoring of the foodstuffs F on the tray 40 below the carriage 54. The video from the vision system 60 assists in accurately positioning the carriage 54 over each of the foodstuffs F to be printed with the edible printing 10 when the tray 40 has been positioned by the conveyor 30 at a select location. This is accomplished by identifying and locating a position and height of a markable surface on each foodstuff F. The printhead 70 is mounted to the carriage 54 so that the printhead 70 may selectively reciprocate with respect to the carriage 54, toward and away from the foodstuff F to be printed. Once the carriage 54 has been accurately positioned with assistance from the vision system 60, the printhead 70 is actuated to place edible printing 10 on the surface of the foodstuff F. Additionally, the vision system 60 can be used to grade the foodstuffs F being processed so that individual foodstuffs F can be removed or marked for removal for further processing.

Various printing technologies can be used for the printhead 70. Some examples include, but are not limited to, contact stamping, inkjet spray labeling, roll printing, or other current marking technologies that can use edible ink that is safe for human consumption. The edible printing 10 utilizes a commercially available edible ink, such as those used in marking products supplied by COLORCON® and other suppliers of such products. It is envisioned that the edible ink will not wash off with water and may be safely consumed together with the foodstuff F. While FIGS. 1A and 1B show edible printing 10 on fruits, the teachings herein can be applied to other produce, such as vegetables, as well as to other food and food products, including meats, cheeses, confectionary, baked goods, and candies.

All of the above operations are preferably automated by the controller 80, which may be a microprocessor- or microcontroller-based device, such as a programmable logic controller, connected to appropriate sensors and servomechanisms. The controller 80 can also be programmed via a Human-Machine Interface (HMI), such as a touchscreen, to monitor the rate of processing, determine the information to be printed, determine the type of foodstuff being processed, the volume and weight of the foodstuffs F being processed, etc. based upon user requirements and input.

The method of edible printing on foodstuffs can be achieved by performing the following steps: procuring a supply of edible ink to be applied to desired type of foodstuff F; loading the edible ink into the printhead 70; selecting a particular tray 40 having correspondingly shaped cavities 42 to the foodstuffs F; placing the tray 40 onto an entrance end portion of the conveyor 30; starting the printing workstation using the controller 80, thereby automatically motioning the tray 40 under the gantry frame 24; locating each piece of foodstuff F using the vision system 60; applying a respective informational marking 12 upon each foodstuff F; automatically motioning the tray 40 outwardly to an exit end portion of the conveyor 30 for unloading; and repeating the loading, marking, and unloading process as desired. The automated processing described above provides a high-volume edible ink marking processing of the foodstuff F.

The method of edible printing on foodstuffs to mark a different kind of foodstuff F can be achieved by performing the following steps: selecting another type of tray 40 suited to an anticipated foodstuff F; reprogramming the printing workstation for the new type of foodstuff F via the controller 80; loading the trays 40 with the new foodstuffs F; and, processing the foodstuffs F through the printing workstation as described above.

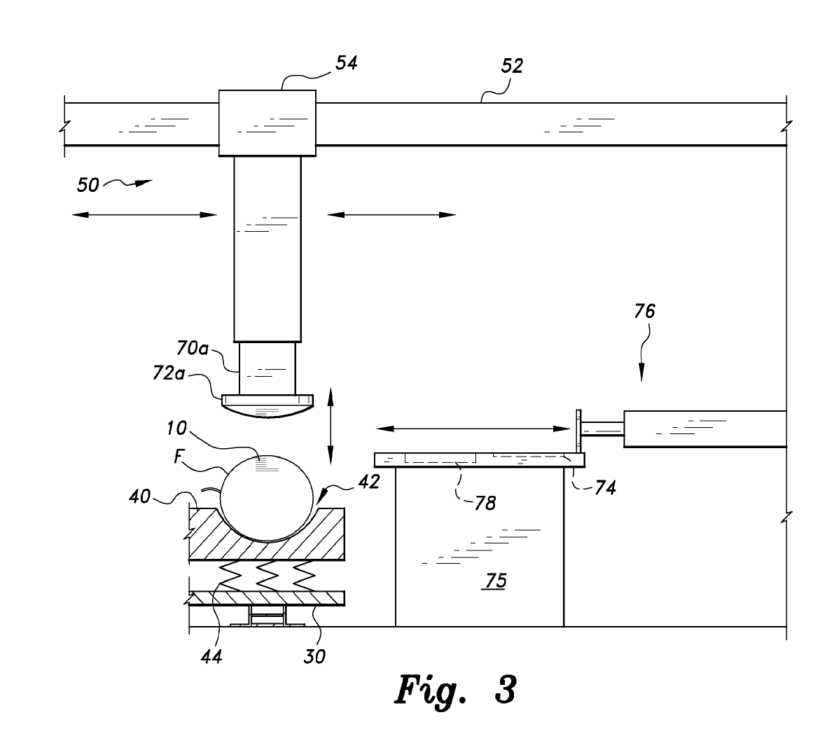

An example of a contact stamp printing device is shown in FIG. 3. In this printing station, the printhead 70a includes a print pad 72a disposed at the bottom thereof. The print pad 72a is preferably constructed from silicon rubber having enough resilience that the pad 72a will not damage the foodstuff F to be stamped. The printing station includes a table 75 offset from the conveyor 30. An etch section 78 and an ink pad 74 containing a supply of edible ink is provided on the table 75. A wiper 76 is disposed adjacent the table 75 to scrape off excess ink. In use, the printhead 70a travels to the etch station 78 to have the desired marking etched onto the print pad 72a. Then the carriage 54 travels to the ink pad 74 to obtain a charge of ink. Once charged, the print pad 72a is transferred over to the target foodstuff F to have the edible printing 10 pressed thereon. Alternatively, the etch section 78 can hold a plurality of different interchangeable print pads 72 or stamp pad sections with different markings thereon. The differentiating information represented by these markings can include codes for different types of foodstuff F being processed, grade, quality and the like.

In order to further protect the foodstuffs F during the printing or marking process, a dampener 44 can be provided between the tray 40 and the conveyor 30. The dampener 44 absorbs some of the pressure from the printhead 70a as the printhead 70a presses the edible marking 10 thereon. It is noted that the dampener 44 can also be used in any of the embodiments described herein.

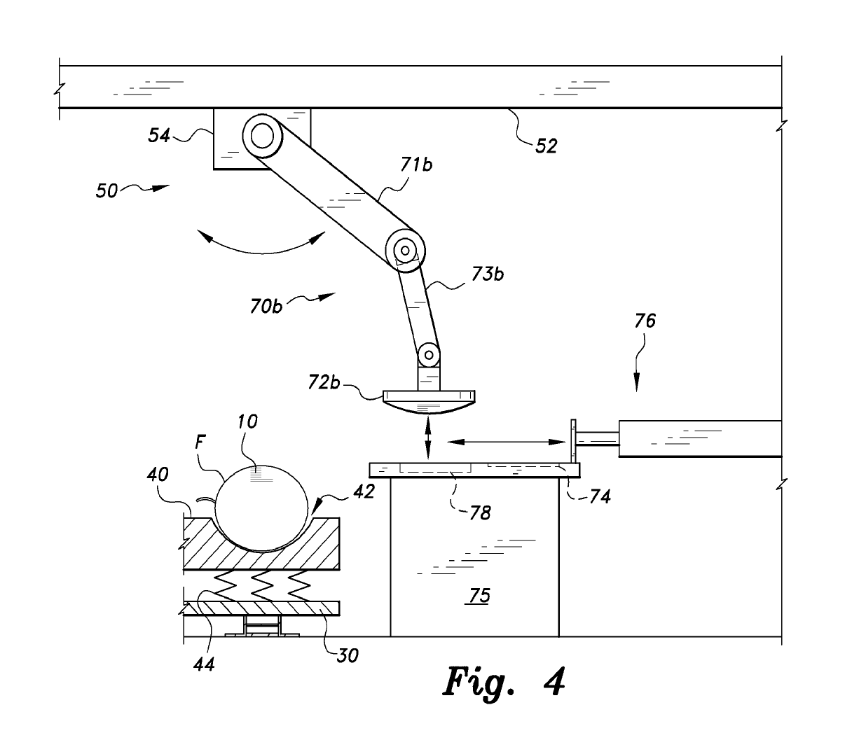

An example of an alternative contact stamp printing device is shown in FIG. 4. In this printing station, the printhead 70b is constructed as an articulating arm having a first section 7 lb pivotally attached to the carriage 54 at one end and a second section 73b pivotally attached to the opposite end of the first section 7 lb. A print pad 72b is pivotally attached to the distal end of the second section 73b. In this embodiment, the stamp printing is achieved via relative pivoting movement of the print pad 72b, rather than a straight line reciprocating motion. In all other respects, this embodiment functions the same as that described above with respect to FIG. 3.

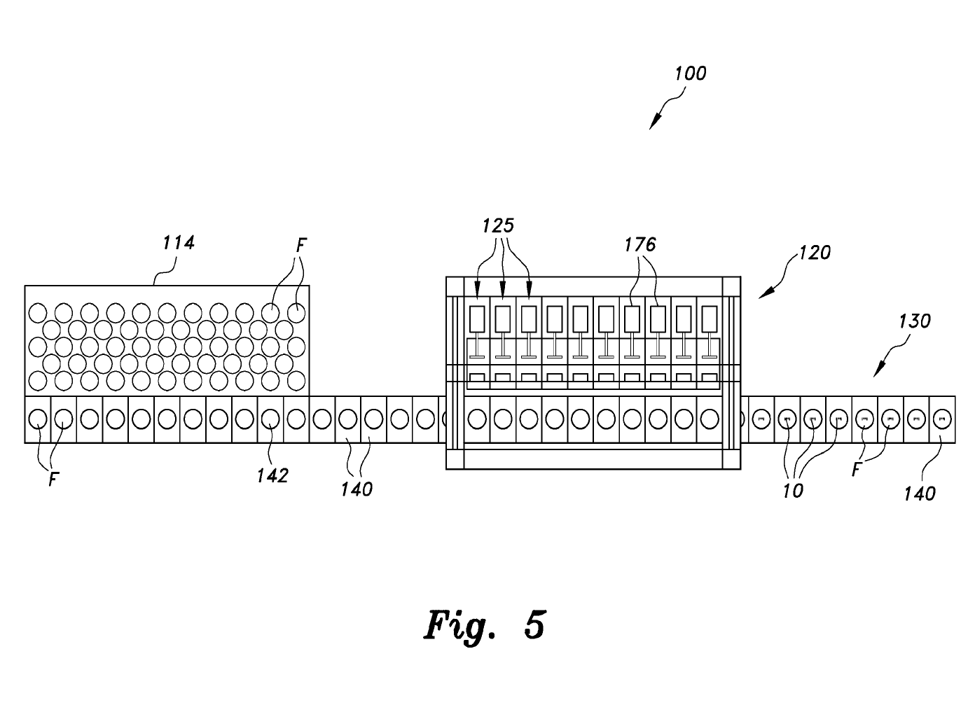

FIG. 5 shows an example of edible printing on foodstuffs in a large processing environment. In this embodiment, a food processing plant 100 includes a supply section having a foodstuffs storage bin or hopper 114 at an entrance end of a conveyor 130. The bin 114 holds the foodstuffs F to be processed, and the foodstuffs F are placed in the cavities 142 on the trays 140. The conveyor 130 carries the plurality of foodstuff processing trays 140 filled with the foodstuff F from the bin 114 towards the printing workstation 120. The printing workstation 120 includes a plurality of printing substations 125 arranged along the path of the conveyor 130. Here, a predetermined number of foodstuffs F are printed with edible printing 10 in select batches and conveyed downstream towards the exit end of the conveyor 130 for further processing.

It can be seen that the food processing plant 100 affords a much larger scale of placing edible printing 10 onto a higher volume of foodstuffs F in a relatively fast manner. The printing workstation 120 can incorporate any of the printing stations described above with respect to FIGS. 2-4. When using the print station of FIG. 2, a plurality of printheads 70 can be arranged in a row along the downstream direction of conveyance and programmed to print the edible printing 10 in various sequences, e.g., concurrent printing, sequential printing, alternate printing, etc. subject to the requirements of the user. Should one fail, the remainder can be programmed to compensate. Although the drawing show a single foodstuff F placed in individual trays 140, the trays 140 can be constructed to hold a line or row of foodstuffs F so that each row can be printed by a single printhead 70. Similar arrangements can be made when using the printheads 70a, 70b. Moreover, the food processing plant 100 can be provided with additional stations for grading and weighing the foodstuffs F being processed. In the case of the former, the vision system 60 can be used to perform quality checks. Any rejected specimen can be offloaded by scrapers 176 or the like to be processed for other use. In the case of the latter, a weighing station can be provided near the exit end of the conveyor 130 to weigh the processed foodstuffs F prior to further processing.

It is noted that the method and device for edible printing on foodstuffs encompasses a variety of alternatives. For example, although the tray 40 has been shown with the cavities 42 arranged in a matrix of columns and rows, the cavities 42 can be constructed and arranged in any manner from the single cavity 142 in the trays 140 to a staggered or offset pattern. A variety of different kinds of edible inks can be used with a wide palette of colors and visibility, including ones visible in certain lighting conditions.

It is to be understood that the present invention is not limited to the embodiments described above, but encompasses any and all embodiments within the scope of the following claims.

We claim:

1. A device for edible printing on foodstuffs, comprising:
a base;
a conveyor mounted to the base;
a gantry frame mounted to the base above the conveyor;
at least one foodstuff processing tray disposed on the conveyor to be carried thereon, the at least one foodstuff processing tray having at least one cavity adapted for snugly holding a foodstuff therein;
at least one printing station disposed on the gantry frame, the at least one printing station having:
a multi-axis manipulator mounted on the gantry frame;
a printhead mounted on the multi-axis manipulator, the printhead having a supply of edible ink adapted for marking edible printing onto a surface of the foodstuffs on the foodstuff processing tray, the multi-axis manipulator being movable in at least two-degrees of freedom for accurately positioning the printhead over a target foodstuff; and
a controller for automatically controlling processing of the foodstuffs;
wherein the edible printing provides information relevant to the foodstuff being processed.

2. The device for edible printing on foodstuffs according to claim 1, wherein said conveyor comprises an endless belt.

3. The device for edible printing on foodstuffs according to claim 1, wherein said at least one cavity is shaped to conform to a shape of said foodstuff being processed.

4. The device for edible printing on foodstuffs according to claim 3, wherein said at least one foodstuff processing tray comprises a plurality of cavities for holding a plurality of foodstuffs therein.

5. The device for edible printing on foodstuffs according to claim 1, wherein said multi-axis manipulator comprises:
an elongate crossbeam movably mounted on the gantry frame, the crossbeam being movable in a direction parallel to direction of movement of the conveyor;
a carriage movably mounted to said crossbeam, the carriage being movable along the length of the crossbeam perpendicular to the direction of movement of the conveyor, the printhead being mounted on the carriage for reciprocating movement toward and away a foodstuff to be printed; and
a vision system attached to the carriage, the vision system providing visual information for accurately positioning the printhead over the target foodstuff to be imprinted with edible printing.

6. The device for edible printing on foodstuffs according to claim 5, further comprising a print pad attached to said printhead, the print pad having informational markings thereon.

7. The device for edible printing on foodstuffs according to claim 6, further comprising:
a table adjacent said conveyor, the table having an etching section for etching informational markings and an ink pad for supply of said edible ink to said printhead; and
a scraper adjacent the table, the scraper selectively scraping excess edible ink from the table.

8. The device for edible printing on foodstuffs according to claim 6, wherein said printhead comprises an articulating arm having a first section pivotally attached to said carriage and a second section pivotally attached to the first section, said print pad being pivotally attached to the second section.

9. The device for edible printing on foodstuffs according to claim 1, further comprising a storage bin disposed at an upstream end of said conveyor, the storage bin holding a plurality of foodstuffs to be processed, said at least one printing station comprising a plurality of printing stations disposed on said gantry frame, the plurality of printing stations facilitating printing of a plurality of foodstuffs at a time.

10. A method for edible printing on foodstuffs, comprising the steps of:
providing a device for edible printing on foodstuffs, the device having:
a base;
a conveyor mounted to the base;
a gantry frame mounted to the base above the conveyor;
at least one foodstuff processing tray disposed on the conveyor to be carried thereon, the at least one foodstuff processing tray having at least one cavity for snugly holding a foodstuff therein;
at least one printing station disposed on the gantry frame, the at least one printing station comprising:
a multi-axis manipulator mounted to the gantry frame;
a vision system mounted to the multi-axis manipulator;
a printhead mounted to the multi-axis manipulator, the printhead having a supply of edible ink for marking edible printing onto a surface of the foodstuffs on the foodstuff processing tray, the multi-axis manipulator being movable in at least two-degrees of movement for accurately positioning the printhead over a target foodstuff; and
a controller for automatically controlling processing of the foodstuffs;
procuring a supply of edible ink;
loading the supply of edible ink to the printhead;
selecting a desired tray corresponding to the foodstuffs;
placing the foodstuffs on the desired tray;
loading the desired tray onto the conveyor;
starting the device for edible printing on foodstuffs with the controller;
automatically conveying the desired tray under the gantry frame;
locating the food stuffs on the tray with the vision system;
applying edible printing upon each the foodstuffs with the printhead;
automatically conveying the desired tray to an exit end of the conveyor;
unloading the desired tray from the conveyor; and
repeating the loading the desired tray, applying edible printing, and unloading the desired tray steps as desired.
